(19) United States
(12) Patent Application Publication
(10) Pub. No.: US 2016/0381351 A1
(43) Pub. Date: Dec. 29, 2016

(54) TRANSPARENT AUTOSTEREOSCOPIC DISPLAY

(71) Applicant: KONINKLIJKE PHILIPS N.V., Eindhoven (NL)

(72) Inventors: BART KROON, EINDHOVEN (NL); MARK THOMAS JOHNSON, ARENDONK (BE); OLEXANDR VALENTYNOVYCH VDOVIN, MAARHEEZE (NL)

(73) Assignee: Koninklijke Philips N.V., Eindhoven (NL)

(21) Appl. No.: 14/771,567

(22) PCT Filed: Feb. 25, 2014
(86) PCT No.: PCT/IB2014/059221

§ 371 Date: Aug. 31, 2015

Related U.S. Application Data
(60) Provisional application No. 61/776,187, filed on Mar. 11, 2013.

(51) Int. Cl. H04N 13/04; G02B 27/22

(52) U.S. Cl. CPC H04N 13/0404; G02B 27/2214; H04N 13/0422; H04N 2213/001

(57) ABSTRACT

A 3D lenticular display is formed using vertically spaced stripe-shaped displays. Each such stripe has the function of a scanline so the vertical resolution of the display is determined by the number of stripes. The stripes consist of an emissive layer and a lenticular lens. The display is at least partially transparent by virtue of the spacing between stripes.

### FIELD OF THE INVENTION

This invention relates to transparent displays, and in particular to transparent autostereoscopic displays.

### BACKGROUND OF THE INVENTION

Transparent displays enable a background behind the display to be viewed as well as the display output. The display thus has a certain level of transmittance. Transparent displays have many possible applications such as windows for buildings or automobiles and show windows for shopping malls.

It is expected that much of the existing display market will be replaced by transparent displays, for example in the fields of construction, advertisement and public information. Transparent displays are not yet available with 3D viewing capability, and in particular not yet using glasses-free autostereoscopic approaches, such as with lenticular lenses.

A transparent display typically has a display mode when the viewer is intended to view the display content, and a window mode when display is off and the viewer is intended to be able to see through the display. A conventional combination of a lenticular lens on top of a display, as is common in autostereoscopic 3D displays, causes a problem if the display is transparent as the lenticular lens will cause a distorted view of the image behind the display. Thus, the window mode does not provide a proper view of the scene behind the window.

### SUMMARY OF THE INVENTION

The invention is defined by the claims.

According to one aspect of the invention, there is provided a display comprising a plurality of display stripes, each comprising one or more rows of pixels and a lenticular arrangement for directing the pixel output from different pixels in different directions thereby enabling autostereoscopic viewing, wherein the stripes are spaced apart in the pixel column direction, with a transmissive spacing between the stripes.

The spacing enables the display to be transmissive. In this design, each stripe has the function of a scanline (or multiple scanlines). The vertical resolution of the display is thus determined by the number of stripes. The stripes consist of at least an emissive layer and a lenticular lens with appropriate spacing to have sufficient focus on the emissive layer.

Each display stripe can comprise a reflector, an emissive display arrangement over the reflector, a spacer over the emissive display arrangement and a lenticular lens array over the spacer. The reflector prevents light from the display exiting the display in the opposite direction (which would give an inverted image).

The lenticular lens array preferably comprises a single row of lenses for each stripe. The lenses in the row can cover one row of sub-pixels or multiple rows of sub pixels, depending on the chosen sub-pixel layout. However, preferably the stripe is for one row of pixels (regardless of whether the sub-pixels are in one or multiple rows) so that the stripe is for one scanline of the image.

The emissive display arrangement can comprise a first emissive display arrangement and each display stripe can then further comprise a second emissive display arrangement over the other side of the reflector to the first emissive display arrangement, such that each stripe comprises two emissive display arrangements facing in opposite directions. One display arrangement can be for autostereoscopic display, and the other can be for 2D display. In this way, the display can present 3D image data in one direction (e.g. to the outside of a window where the position of the viewer is known) and 2D image data in the other direction (e.g. to the inside of a shop where there are many viewers at different positions).

The stripes are preferably mounted on a support, which can be a glass support. This support can be the structure to which the display is to be fixed, such as a window, or it can be part of the display structure.

The display stripes can comprise a first plurality of display stripes provided over one side of a support, and a second plurality of display stripes provided over the other side of the support.

This enables 3D images to be provided in both directions from the display. Each of the second plurality of display stripes can thus also comprise one or more rows of pixels and a lenticular arrangement for directing the pixel output from different pixels in different directions thereby enabling autostereoscopic viewing, wherein the stripes are spaced apart in the pixel column direction, with a transmissive spacing between the stripes. Preferably, the first and second display stripes are aligned to maximise the transmissive area.

In one set of examples, the stripes are fixed in position. They can be fixed perpendicular to the plane of the display or at an angle to the perpendicular (i.e. with the transmissive spacing suitably aligned with the intended position of the viewer.

Alternatively, the stripes can be pivotable about a pixel row direction. This means the direction can be tilted up and down to match the viewer position.

Each stripe can have reflective upper and lower inner surfaces. These ensure that light exiting the stripes has a wide vertical angular spread. Each stripe can have specular reflective upper and lower outer surfaces. These reduce image distortion for the transmissive (window) mode or the visibility of the scene behind the display in the display mode.

The height of the transmissive spacing is at for example least double the height of a display stripe. This means the transmissive function is effective.

### BRIEF DESCRIPTION OF THE DRAWINGS

An example will now be described in detail with reference to the accompanying drawings, in which:

FIG. 1 shows the design of a display stripe used in the display of the invention;

FIG. 2 shows three views of a first example of display of the invention;

FIG. 3 shows the layers of the display stripe in more detail;

FIG. 4 shows alternative layers for the display stripe;

FIG. 5 shows a first possible pixel layout;

FIG. 6 shows two possible alternative pixel layouts;

FIG. 7 shows two views of a second example of display of the invention;

FIG. 8 shows a third example of display of the invention;

FIG. 9 shows how the stripes can be tilted to match the position of a viewer;

FIG. 10 shows the effect of transmissive light hitting the stripes; and

FIG. 11 shows a further alternative stripe design.

### DETAILED DESCRIPTION OF THE EMBODIMENTS

The invention provides a 3D lenticular display which is formed using vertically spaced stripe-shaped displays. Each such stripe has the function of a scanline so the vertical resolution of the display is determined by the number of stripes. The stripes consist of an emissive layer and a lenticular lens. The display is at least partially transparent by virtue of the spacing between stripes.

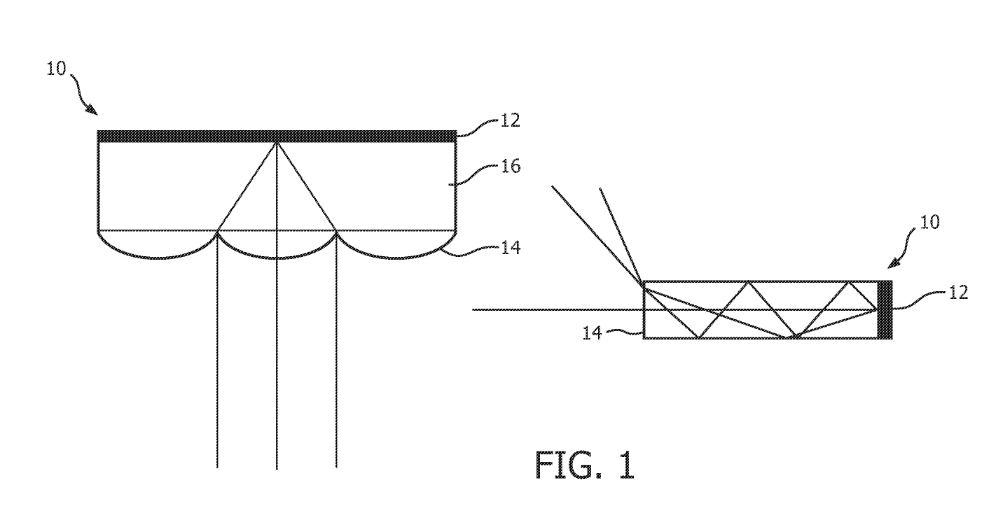

FIG. 1 shows a top view and a side view of a single such stripe 10. The stripes consist of at least an emissive layer 12 and a lenticular lens 14 with appropriate spacing 16 to focus on the emissive layer 10.

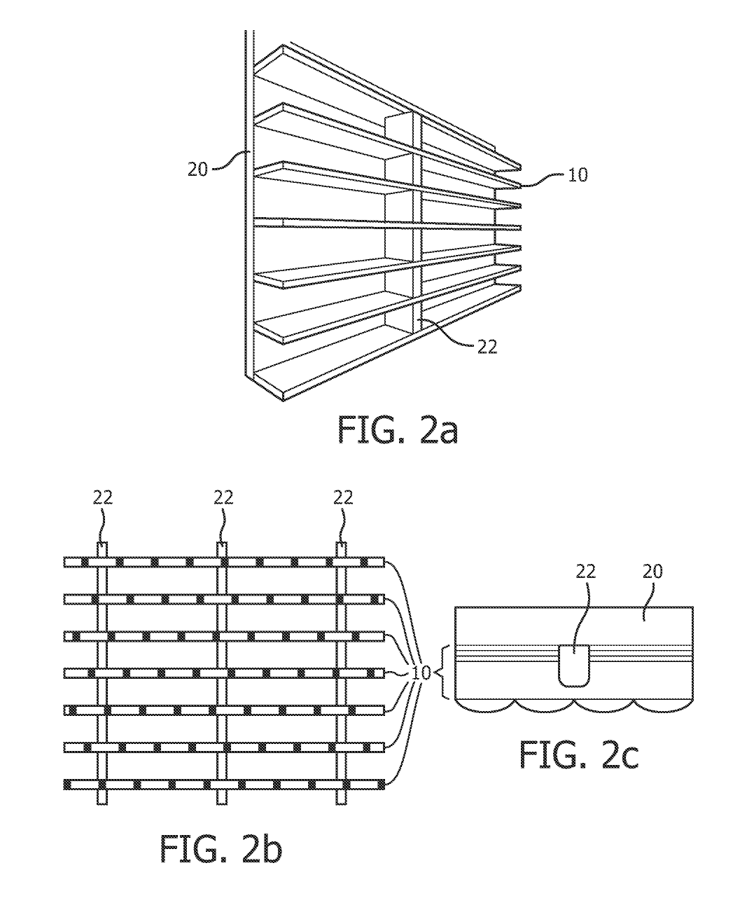

FIG. 2 shows one example of the overall display configuration. FIG. 2(a) shows a perspective view (without showing the lens shape), FIG. 2(b) shows the front view and FIG. 2(c) shows a top view.

The display comprises a glass support 20 with stripes 10 on one side and optionally vertical supports 22 to preserve structural integrity.

The stripes 10 each comprise a row of display pixels with a lens arrangement associated with the pixels. Each lens typically overlies a sub-array of pixels so the light from different pixels is imaged by the associated lens to a particular direction (in well-known manner).

The example of FIG. 2 displays a 3D image to one side only, and the stripes are fixed to the support 20.

Without the glass support 20, the stripes may act as blinds, either at a fixed angle or rotatable, depending on the implementation of the vertical supports.

Furthermore, 3D viewing from both sides is possible by applying stripes to both sides of a glass support. In this case, it is desirable that stripes on each side are preferably aligned to maximize transmission of ambient light. Again, the support may not be needed.

Each stripe has reflective upper and lower boundary surfaces (as shown in the side view in FIG. 1). In this way, the lenticular stripe acts as a full lenticular sheet due to these reflections on the top and bottom of the stripe. Light emitted at the back focal plane, passing through the lenticular stripe has a narrow horizontal distribution, but is spread out vertically. The top and bottom surfaces of the stripes preferably have a specular coating.

The areas between the stripes allows for transmission of ambient light.

Typically, a glass support 20 can be used as a basis for the 3D display. In the application of an interactive shop window or a public information display, this glass support is actually the glass window, or a layer that will be laminated on top of a window. The stripes 10 are placed on top of the glass support. Optionally, the vertical supports 22 can be used to strengthen the display.

The vertical resolution of the display is determined by the number of stripes, since each stripe provides a row of pixels. The horizontal and angular resolution is determined by the resolution and lens shapes of the stripes.

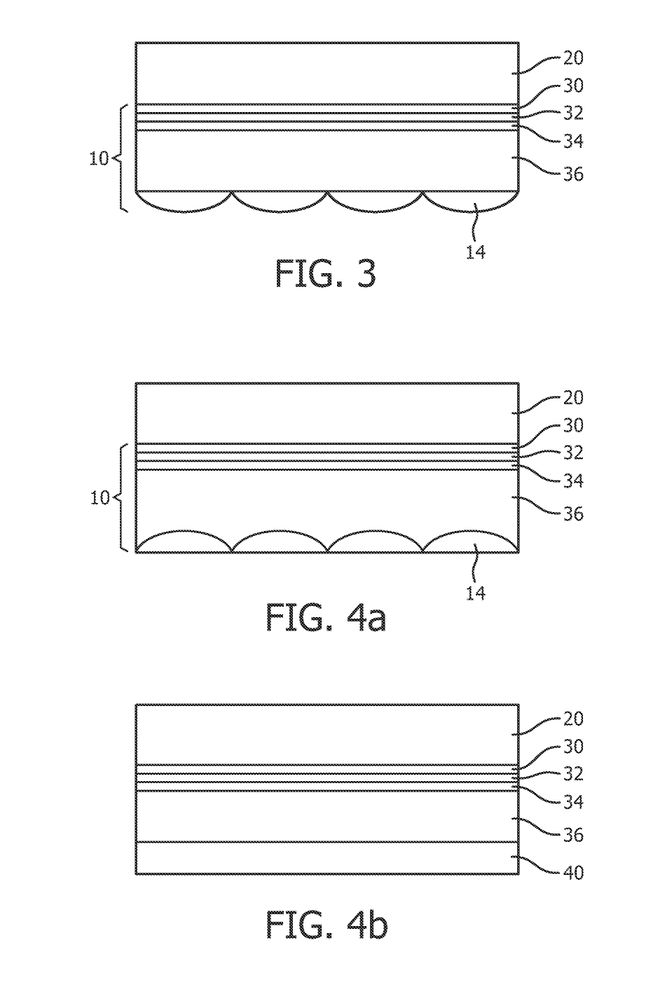

FIG. 3 shows an example of one possible structure of the stripe in more detail. Over the glass support interface 20, there is provided a reflective layer 30, an emissive layer 32 including driving electronics (e.g. active or passive matrix), a transparent top electrode 34, a spacer layer 36, and then the lenticular lenses 14.

A typical emissive technology is organic light emitting diodes (OLEDs) but alternatives such as organic light emitting transistors (OLET) or quantum dots (QDOT) exist. Electroluminescent displays or discrete LEDs can instead be used. A wave guided light source with light out-coupling structures and an electro-optical shutter such as LCD can also be employed.

The reflective layer 30 not only improves the light efficiency, but also prevents light from leaving the glass support through the other side. This is avoided because without a lenticular sheet on the opposite side, the image as viewed from the other side would be distorted as well as appearing mirrored.

The optical parameters of the lenticular stripes are designed using the same approach as for conventional lenticular autostereoscopic displays. The lenticular pitch (as a function of the pixel pitch) determines the effective number of views. The number of views is at least two.

The viewing cone half-angle determines the angular width of the views. The focal length is typically chosen to fit with the desired cone angle and lenticular pitch.

The thickness of the stripe is determined by the chosen focal length and the refractive indices of the materials. The lenticular stripes should be thin enough to allow for sufficient transmission of ambient light, and thick enough to create enough emissive surface and material strength.

The lens shape as shown in FIG. 3 is just one example. Alternatives are shown in FIG. 4, in which FIG. 4(a) shows a solid stack with a flat outside surface and the lenses facing inwardly. The separating layer can be air in this case. FIG. 4(b) shows a lens stack making use of other lens types 40, which can be graded refractive index (GRIN) lenses, electrowetting lenses, diffractive lenses (i.e. linear Fresnel zone plates), or Fresnel lenses. The lens arrangement can be switchable for example as is possible with LC birefringent-based lenses, electrowetting lenses and or LC GRIN lenses.

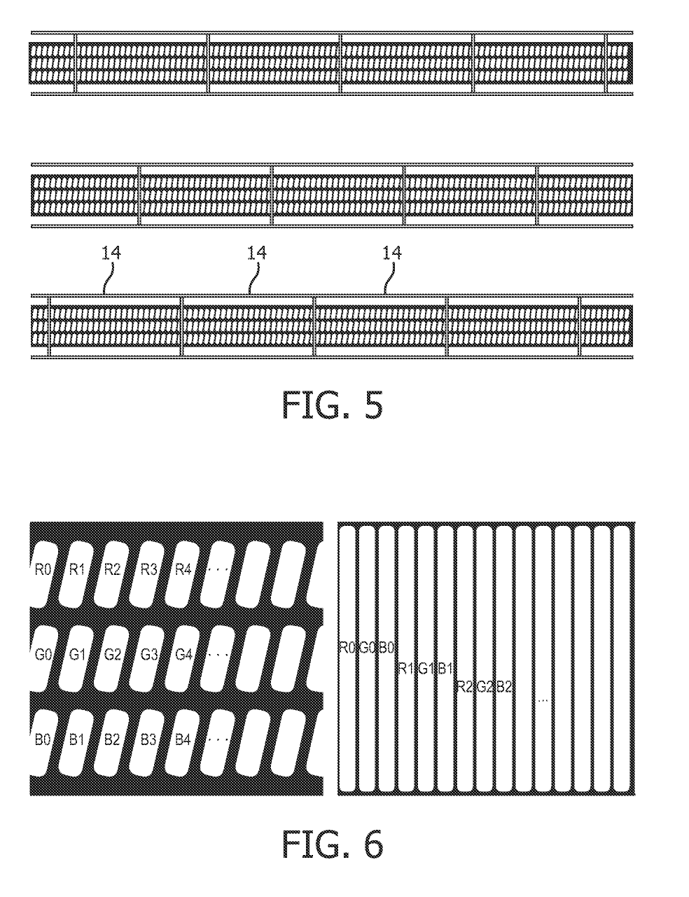

FIG. 5 shows a preferred slanted pixel pattern in which each lens 14 covers three rows of sub-pixels (arranged as RGB rows). As horizontal resolution is more important than the vertical resolution, it is preferred to have the colour components in the vertical direction (i.e. three rows of pixels) and different views provided by the pixels in the horizontal direction. Rotation of the RGB color components (so that each row is an RGB sequence rather than all of one colour) may slightly improve uniformity, but fixed colour rows may be simpler to manufacture.

FIG. 6 shows two alternative pixel layouts. The left image shows slanted pixels, with one colour per row, whereas the right image shows a single row of sub pixels, so that three sub-pixels along the row direction form each pixel triplet.

Banding due to non-emissive parts of the pixel structure can be mitigated by changing the pixel shape, for instance by slanting them as is shown in the left image of FIG. 6. A wide range of other pixel shapes is possible.

An example of the possible dimensions will now be presented.

For a window display, the display can be 2 m wide and 1 m tall, and an effective resolution per view can be around 2 megapixels or 2000×1000 pixels. An intended viewing distance can be 3 meters, and for that distance the separation between two consecutive (real) views should be approximately equal to the interocular distance or 60 mm.

A cone that has a width of 600 mm at 3 m (5.7 degrees half-angle) allows for comfortable viewing when sitting or walking around. This means that a lenticular pitch of 600/60=10 sub pixels is sufficient.

Using the pixel layout of the left part of FIG. 6 (with one pixel triplet having the width in the row direction of only one sub-pixel), the smallest (3D) unit cell (i.e. set of pixels) is 10 sub-pixels wide for the 10 views and 3 sub-pixels high (R, G and B). The lenticular pitch is 2 m divided by 2000 which equals 1 mm, such that the horizontal sub-pixel pitch should be 100 μm. Having a cone ratio of 600:3000 (the ratio between cone width at the optimal viewing distance and that optimal viewing distance) and a pitch of 1 mm, the focal length has to be close to 5 mm.

The pitch of the stripes in the vertical direction is also 1 mm (1 m divided by 1000 pixels).

With the simple optical design from FIG. 3 and the index of refraction 1.5, and neglecting the thickness of the display layers, the thickness of the lenticular stripe (i.e. how far it extends from the glass support) is about 7.5 mm.

Assuming that the display cannot be directly touched or has a protective cover glass, then a stripe height of 200 μm is strong enough. Thus, for optimal angles transmission of ambient light is (1 mm minus 200 μm) divided by 1 mm, equals 80%, minus any glass reflections. The vertical sub-pixel pitch for three rows of sub pixels becomes 67 μm. Thus, it can be seen that for a sufficiently large display, 80% transmission is possible while maintaining an equal vertical pixel pitch and horizontal lens pitch. This means a viewed 3D image has a uniform pixel pitch in the row and column directions (of 1 mm in this example).

The invention can be modified to enable 3D viewing on one side, and 2D viewing on the other side.

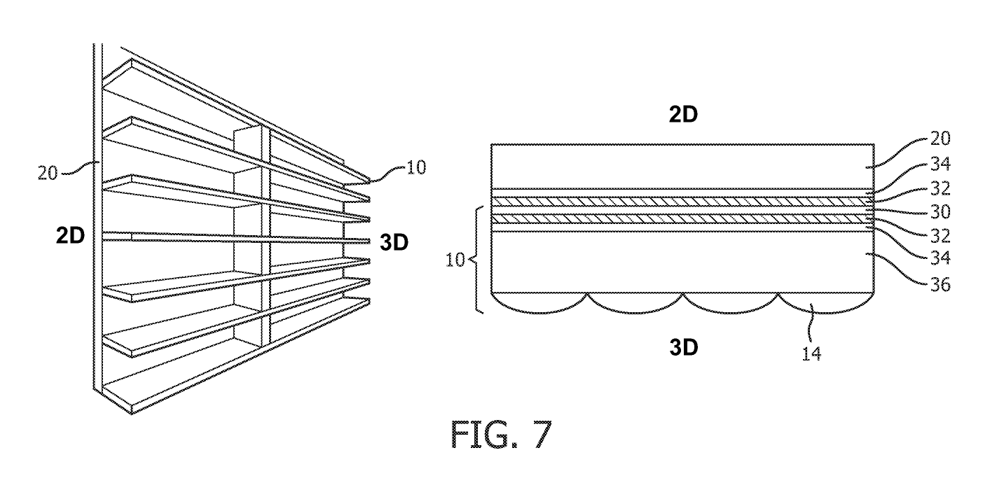

FIG. 7 shows this modification, in perspective view on the left and top view on the right. The reflector 30 is sandwiched between two emissive stacks 32 (emissive layer) and 34 (top electrode). Different pixel layouts may be used for the two viewing sides, for example with a larger pitch on the 2D viewing side.

The stripe arrangement means the look through function is still effective, in both directions through the display.

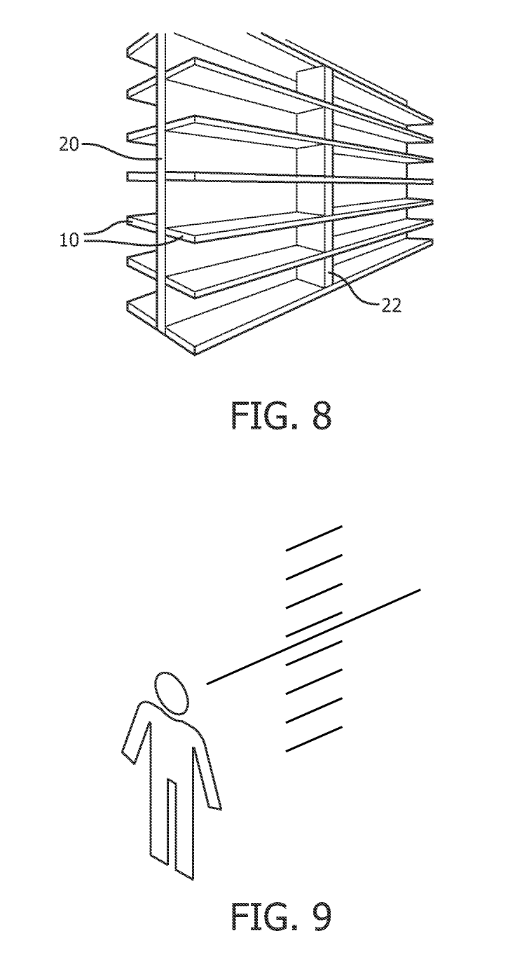

The invention can also be modified to provide 3D viewing on both sides, by providing the stripes 10 on both sides of a glass support 20 as shown in FIG. 8. The stripes are then preferably aligned to maximize transmission of the ambient light. This version requires two emissive stacks.

In the examples above, the glass stripes 10 are held in place by the glass support 20, with optional vertical supports 22. It is however conceivable that the invention is used without a glass support 20 in which case structural integrity as well as alignment is created by the vertical supports 22.

In this case, the display can be adjusted in the manner of venetian blinds. In the examples above, the stripes 10 are placed perpendicularly to the glass support 20, but if the intended viewing direction of the display is off-axis as shown in FIG. 9, the stripes could be rotated to allow for a better ambient view. The rotation of the stripes could be predetermined (static) or adjustable through manual or automatic (e.g. electric) operation.

The invention makes a trade-off between the transmission of ambient light and the display of 3D information. The stripes extend from the glass support by some distance, as the lenticular lenses require a reasonable focus on the top of the glass support. This limits ambient light with large oblique angles from transmitting through the glass support. This is not unlike the situation with regular venetian blinds.

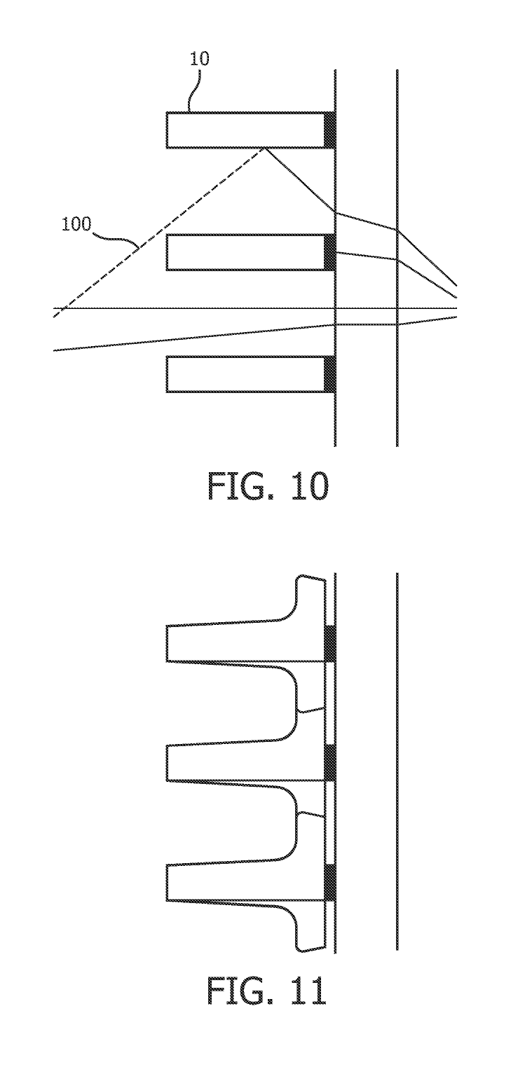

FIG. 10 shows what happens to ambient light 100 transmitted through the glass support at oblique angles. With reflective top and bottom outer surfaces sides of the stripes 10 (which will result if there is no coating), light may be deflected to have a different vertical angle as shown. This creates a vertical diffusion effect of the ambient light. It is possible that this effect is desired by a designer, but when considered a problem, the stripes 10 can be coated to diffusely reflect or absorb ambient light. To maintain the 3D display effect, which requires total internal reflection within the stripes, a reflective coating can be applied first.

The preferred way to manufacture the transparent display with glass stripes is to cast the glass for all stripes 10 as one piece. When cooled down, the conductive, reflective and emissive layers can be formed by lithographic processes while the stripes are still in the mould. The vertical supports 22 can be part of the mould or could be added followed by the glass support 20. Care should be taken not to stress the emissive layer as it is typically fragile.

The glass could be replaced by plastic, i.e. a transparent polymer, whereby the shape could be formed by an injection moulding technique. FIG. 11 shows an exaggerated example of how such a moulded form could be shaped. With such a form vertical supports may not be required. The stripes 10 are formed are projections extending from a continuous base.

The invention relates to transparent 3D displays for any desired application, for example for interactive shop windows.

In the example given above, the transmissive area is 80% of the display area. More generally, the transmissive area is greater than 50% of the area, and more preferably more than 75%. By using bright emissive pixels, even though each pixel occupies a relatively small area (in the column direction), compared to the pixel pitch, a good quality image can be obtained. The invention is of particular interest for large displays viewed from a significant distance, since the implementation is then more practical.

As mentioned above, the spacing between the display stripes is transmissive (i.e. transparent) to allow viewing of the scene behind. Of course, perfect transparency is not essential, and indeed the support 20 will not in practice be perfectly transparent. The word “transmissive” should be understood accordingly, representing a sufficient level of transparency for a viewer to look through that part of the display. For example at least 50% transparency to the visible light spectrum is sufficient (for the spacing between stripes), although more than 75% or 85% transparency is preferred.

There can be one row of pixels per stripe, and as discussed above this means the pixels can form a regular grid—if desired with the same pixel pitch in the column direction as the pixel pitch between the same views in the row direction (i.e. the lens pitch). These pitches do not need to be identical however. Furthermore, there can be multiple pixel rows in each stripe. This will result in a non-uniform pixel grid, but can provide a display effect which is still desirable.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A display comprising a plurality of display stripes, each stripe comprising:
one or more rows of pixels; and
a lenticular arrangement for directing the pixel output from different pixels in different directions thereby enabling autostereoscopic viewing,
wherein the stripes are spaced apart in the pixel column direction, with a transmissive spacing between the stripes.

2. A display as claimed in claim 1, wherein each display stripe comprises a reflector, an emissive display arrangement over the reflector, a spacer over the emissive display arrangement and a lenticular lens array over the spacer.

3. A display as claimed in claim 2, wherein the lenticular lens array comprises a single row of lenses for each stripe.

4. A display as claimed in claim 2, wherein the emissive display arrangement comprises a first emissive display arrangement and each display stripe further comprises a second emissive display arrangement over the other side of the reflector to the first emissive display arrangement, such that each stripe comprises two emissive display arrangements facing in opposite directions.

5. A display as claimed in claim 4, wherein the stripes are mounted on a support.

6. A display as claimed in claim 1, wherein the display stripes comprise a first plurality of display stripes and are provided over one side of a support, and wherein a second plurality of display stripes is provided over the other side of the support.

7. A display as claimed in claim 6, wherein each of the second plurality of display stripes comprise one or more rows of pixels and a lenticular arrangement for directing the pixel output from different pixels in different directions thereby enabling autostereoscopic viewing, wherein the stripes are spaced apart in the pixel column direction, with a transmissive spacing between the stripes.

8. A display as claimed in claim 7, wherein the first and second display stripes are aligned.

9. A display as claimed in claim 1, wherein the stripes are fixed in position.

10. A display as claimed in claim 9, wherein the stripes are fixed in position perpendicular to the plane of the display or at an angle to the perpendicular.

11. A display as claimed in claim 1, wherein the stripes are pivotable about a pixel row direction.

12. A display as claimed in claim 1, wherein each stripe has reflective upper and lower inner surfaces.

13. A display as claimed in claim 12, wherein each stripe has specular reflective upper and lower outer surfaces.

14. A display as claimed in claim 1, wherein the height of the transmissive spacing is at least double the height of a display stripe.

15. A display as claimed in claim 1 provided over a window.
